(19) United States
(12) Patent Application Publication
(10) Pub. No.: US 2024/0196269 A1
(43) Pub. Date: Jun. 13, 2024

(54) COMMUNICATION SYSTEM AND VEHICLE DEVICE

(71) Applicant: DENSO CORPORATION, Kariya-city (JP)

(72) Inventors: Tomoyuki MATSUDA, Kariya-city (JP); Yoichi FUKATSU, Kariya-city (JP)

(21) Appl. No.: 18/582,386

(22) Filed: Feb. 20, 2024

Related U.S. Application Data
(63) Continuation of application No. PCT/JP22/31924, filed on Aug. 24, 2022.

(30) Foreign Application Priority Data
Aug. 26, 2021 (JP) 2021-138102

(51) Int. Cl. H04W 28/06; H04L 5/00; H04L 69/22

(52) U.S. Cl. CPC H04W 28/06; H04L 5/0048; H04L 69/22

(57) ABSTRACT

The present disclosure provides a vehicle device that performs bidirectional wireless communication with a communication device. The vehicle device includes a main antenna and at least one sub-antenna. The vehicle device generates first direction information, which indicates a direction from the vehicle device to the communication device, and transmits a communication frame that includes the first direction information via the main antenna. The communication device is a portable device, and includes a transmission reception antenna. The communication device generates second direction information, which indicates a communication direction from the communication device to the vehicle device, and transmits a communication frame that includes the second direction information, in response to reception of signal including the first direction information. The vehicle device determines that a transmission source of the communication frame is the communication device when the communication frame received by the sub-antenna includes the second direction information.

### CROSS REFERENCE TO RELATED APPLICATIONS

The present application is a continuation application of International Patent Application No. PCT/JP2022/031924 filed on Aug. 24, 2022, which designated the U.S. and claims the benefit of priority from Japanese Patent Application No. 2021-138102 filed on Aug. 26, 2021. The entire disclosures of all of the above applications are incorporated herein by reference.

### TECHNICAL FIELD

The present disclosure relates to a communication system that performs bidirectional wireless communication.

### BACKGROUND

There has been known a technology that controls door lock, start of engine, and the like in a vehicle when a portable device carried by a user approaches within a predetermined range from the vehicle.

### SUMMARY

The present disclosure provides a vehicle device used in a communication system which performs bidirectional wireless communication between the vehicle device and a communication device. The vehicle device includes a main antenna performing signal transmitting and signal receiving and at least one sub-antenna, which is different from the main antenna and performs signal transmitting and signal receiving. A communication frame of the wireless communication, which is transmitted in a first direction from the vehicle device to the communication device, is paired with a communication frame of the wireless communication, which is transmitted in a second direction from the communication device to the vehicle device. The vehicle device is configured to: generate first direction information, which indicates a communication direction is the first direction, and transmit the communication frame, which includes the generated first direction information, via the main antenna. The first direction information corresponds to communication direction information, which is included in the paired communication frame and indicates the communication direction of communication frame. The communication device is a portable device, and includes a transmission reception antenna performing signal transmitting and signal receiving. The communication device is configured to generate second direction information, which indicates the communication direction is the second direction, and transmits the communication frame, which includes the generated second direction information, in response to a signal including the first direction information being received via the transmission reception antenna. The vehicle device determines that the transmission source of the communication frame is the communication device when the communication frame received by the at least one sub-antenna includes the second direction information, which corresponds to the communication direction information and indicates that the communication direction is the second direction.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of a communication system;

FIG. 2 is a diagram showing functions of a smart entry start system;

FIG. 3 is a block diagram showing a configuration of a vehicle control unit;

FIG. 4 is a block diagram showing a configuration of a monitoring control unit;

FIG. 5 is a block diagram showing a configuration of a portable control unit;

FIG. 6 is an explanatory diagram for explaining BLE communication;

FIG. 7 is an explanatory diagram for explaining a communication frame;

FIG. 8 is an explanatory diagram for explaining frame division;

FIG. 9 is a flowchart of a vehicle communication process;

FIG. 10 is a flowchart (first part) of BLE communication process executed by a vehicle device;

FIG. 11 is a flowchart (second part) of BLE communication process executed by the vehicle device;

FIG. 12 is a flowchart of a transmission source determination process;

FIG. 13 is a flowchart of a position specifying process;

FIG. 14 is a flowchart of a portable communication process; and

FIG. 15 is a flowchart of BLE communication process executed by a smart device.

### DETAILED DESCRIPTION

In wireless communication technology, whether the portable device has approached within the predetermined range from the vehicle is determined based on a strength of signal transmitted from the portable device. For example, in a known art, in order to detect a position of the portable device, a signal communicated by wireless communication between a device mounted on the vehicle (hereinafter referred to as a master device) and the portable device is received by a monitoring device mounted on the same vehicle.

For example, bidirectional wireless communication under Bluetooth Low Energy (Bluetooth is a registered trademark) standard may be executed between the master device and the portable device.

In Bluetooth Low Energy (hereinafter, referred to as BLE), a communication frame from a master device to a portable device is paired with a communication frame from the portable device to the master device, and communication of the pair frames is repeated. In the paired communication frames, the communication frame is first transmitted from the master device to the portable device, and the other communication frame is transmitted from the portable device to the master device.

For example, it is assumed that while communication is performed between the master device and the portable device, the monitoring device continuously overwrites and stores the strength of received signal in the memory. In BLE, communication needs to be completed within each frequency hopping period. Therefore, when the monitoring device acquires a value to be written in the memory at the end of this period, it is considered that the value can be determined as the reception strength of signal transmitted from the portable device.

While the communication from the portable device to the master device is being performed, a situation may occur in which the communication transmitted from the portable device to the master device is not received by the monitoring device (that is, there is no reception signal). In this case, the signal from the master device may be erroneously determined as a signal from the portable device. That is, the transmission source of the signal may be erroneously determined.

According to an aspect of the present disclosure, a vehicle device used in a communication system is provided. The communication system includes a first communication device and a second communication device, which perform a wireless communication with one another in bidirectional manner. The vehicle device is mounted on a vehicle and corresponds to the first communication device included in the communication system. The vehicle device includes: a main antenna performing signal transmitting and signal receiving; at least one sub-antenna different from the main antenna, and the at least one sub-antenna performing signal transmitting and signal receiving, a communication frame of the wireless communication, which is transmitted in a first direction from the first communication device to the second communication device, being paired with a communication frame of the wireless communication, which is transmitted in a second direction from the second communication device to the first communication device; a first communication execution unit generating first direction information, which indicates a communication direction is the first direction, and transmitting the communication frame, which includes the generated first direction information, via the main antenna, the first direction information corresponding to communication direction information, which is included in the paired communication frame and indicates the communication direction of communication frame; and a determination unit determining whether a transmission source of the communication frame is the second communication device. The second communication device is a portable device, and includes: a transmission reception antenna performing signal transmitting and signal receiving; and a second communication execution unit generating second direction information, which indicates the communication direction is the second direction, and transmitting the communication frame, which includes the generated second direction information, in response to a signal including the first direction information being received via the transmission reception antenna. The determination unit determines that the transmission source of the communication frame is the second communication device when the communication frame received by the at least one sub-antenna includes the second direction information, which corresponds to the communication direction information and indicates that the communication direction is the second direction.

According to another aspect of the present disclosure, a communication system includes a first communication device and a second communication device, which perform a wireless communication with one another in bidirectional manner. The first communication device includes: a main antenna performing signal transmitting and signal receiving; at least one sub-antenna different from the main antenna, and the at least one sub-antenna performing signal transmitting and signal receiving, a communication frame of the wireless communication, which is transmitted in a first direction from the first communication device to the second communication device, being paired with a communication frame of the wireless communication, which is transmitted in a second direction from the second communication device to the first communication device; a first communication execution unit generating first direction information, which indicates a communication direction is the first direction, and transmitting the communication frame, which includes the generated first direction information, via the main antenna, the first direction information corresponding to communication direction information, which is included in the paired communication frame and indicates the communication direction of communication frame; and a determination unit determining whether a transmission source of the communication frame is the second communication device. The second communication device is a portable device, and includes: a transmission reception antenna performing signal transmitting and signal receiving; and a second communication execution unit generating second direction information, which indicates the communication direction is the second direction, and transmitting the communication frame, which includes the generated second direction information, in response to a signal including the first direction information being received via the transmission reception antenna. In the first communication device, the determination unit determines that the transmission source of the communication frame is the second communication device when the communication frame received by the at least one sub-antenna includes the second direction information, which corresponds to the communication direction information and indicates that the communication direction is the second direction.

According to the above configurations, when the second direction information is included in the received communication frame, the first communication device determines that the transmission source of the received signal is the second communication device. Thus, for the reception signal acquired at the preliminarily estimated time (for example, a time corresponding to end of frequency hopping period), it is possible to specify the signal whose transmission source is the second communication device with a higher accuracy compared with a case where the signal strength is always determined to correspond to a strength of signal with the second communication device as the transmission source.

As a result, it is possible to accurately determine the transmission source of signal in the communication system, which includes the first communication device and the second communication device performing the bidirectional wireless communication with one another.

The following will describe embodiments of the present disclosure with reference to the drawings.

### 1. Configuration

### (Overall Configuration)

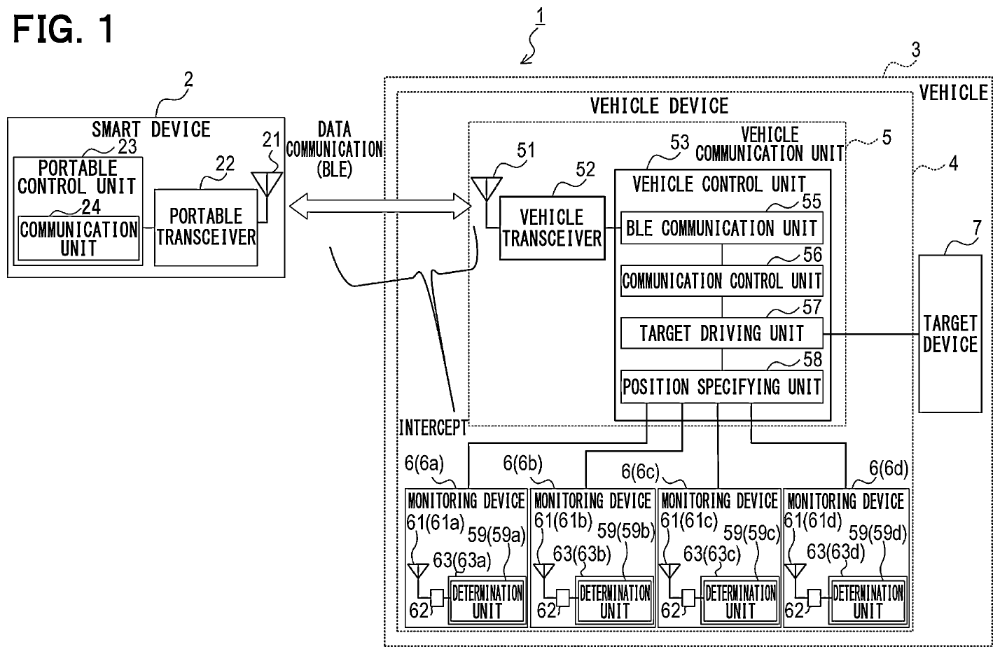

A communication system 1 illustrated in FIG. 1 includes a vehicle device 4 mounted on a vehicle 3 and a portable smart device 2. The portable smart device 2 may be referred to as smart device for simplification. The vehicle device 4 and the smart device 2 execute bidirectional wireless communication according to the Bluetooth Low Energy (hereinafter referred to as BLE) standard. The vehicle device 4 corresponds to a master device, and the smart device 2 corresponds to a slave device. Bluetooth is a registered trademark.

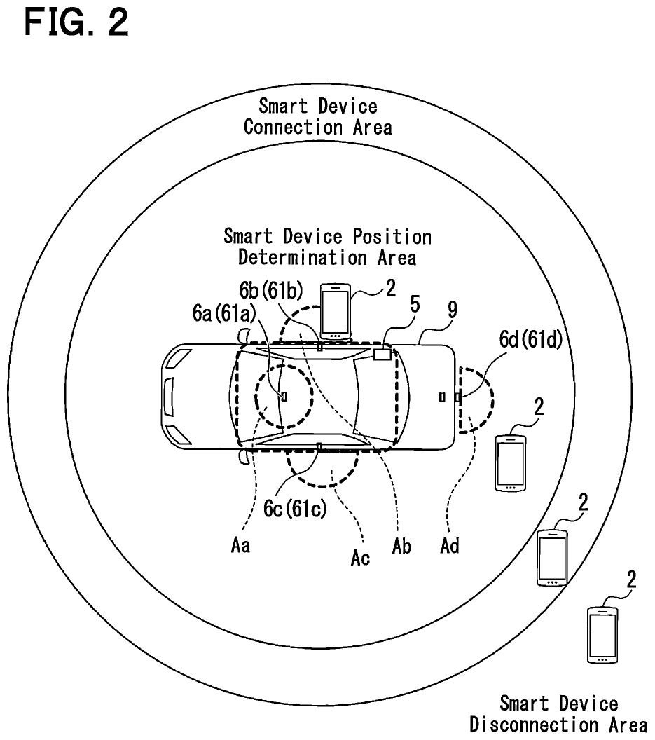

As shown in FIG. 2, when the smart device 2 carried by a user approaches within the predetermined range from the vehicle 3, the vehicle device 4 has a function of enabling lock and unlock of door, start and stop of engine, and the like (that is, a function of well-known smart entry start system). Whether the smart device has approached within the predetermined range (that is, the position of the smart device 2) of the vehicle 3 is determined based on the strength of signal transmitted from the smart device 2 and received by the vehicle device 4 via the BLE communication. BLE communication refers to a communication method conforming to BLE standard.

### 1-1. Vehicle Device

As illustrated in FIG. 1, the vehicle device 4 includes a main antenna 51 and a vehicle control unit 53. The vehicle device 4 may include a vehicle transceiver 52 and a target device 7. The vehicle control unit 53 is provided by an ECU. ECU is an abbreviation for Electronic Control Unit. For example, as illustrated in FIG. 2, a vehicle communication unit 5 may include the main antenna 51, the vehicle transceiver 52, and the vehicle control unit 53, and may be installed in a C pillar located behind a rear seat.

The main antenna 51 is an antenna for transmitting and receiving signals (that is, radio waves) in the 2.4 GHz band used for BLE communication. The vehicle transceiver 52 demodulates a signal received by the main antenna 51 and outputs the demodulated signal to the vehicle control unit 53. The vehicle transceiver 52 modulates a signal output from the vehicle control unit 53 and transmits the modulated signal using the main antenna 51.

The vehicle device 4 includes at least one sub-antenna 61 and at least one monitoring control unit 63. The vehicle device 4 may include at least one monitoring receiver 62. In the present embodiment, as illustrated in FIG. 1 and FIG. 2, the vehicle device 4 includes multiple (for example, four) sub-antennas 61 (that is, 61a, 61b, 61c, and 61d) and multiple (for example, four) monitoring control units 63 (that is, 63a, 63b, 63c, and 63d). The vehicle device 4 includes multiple (for example, four) monitoring receivers 62 (that is, 62a, 62b, 62c, and 62d).

Note that, in the following description, when a description common to individual configurations such as the sub-antenna 61a and the sub-antenna 61b is described, the suffix is omitted, for example, as sub-antenna 61.

The sub-antenna 61 is an antenna for receiving a signal (that is, a radio wave) in the 2.4 GHz band used for BLE communication. As shown in FIG. 2, the sub-antenna 61a may be located in a vehicle compartment, the sub-antenna 61b may be located near the door lock of right door, the sub-antenna 61c may be located near the door lock of left door, and the sub-antenna 61d may be located near the door lock of rear door.

Each of the sub-antennas 61a, 61b, 61c, and 61d is connected to the corresponding monitoring receiver 62 (that is, 62a, 62b, 62c, 62d). Each monitoring receiver 62 is connected to the corresponding monitoring control unit 63 (that is, 63a, 63b, 63c, 63d). A monitoring device 6 to be described below includes one sub-antenna 61, one monitoring receiver 62, and one monitoring control unit 63. The vehicle device 4 may include multiple (for example, four) monitoring devices 6 (that is, 6a, 6b, 6c, 6d).

In the present embodiment, the number of monitoring devices 6 included in the vehicle device 4 is not limited to four. The number of monitoring devices 6 included in the vehicle 3 is plural, for example, two, three, five or more.

### (Vehicle Control Unit)

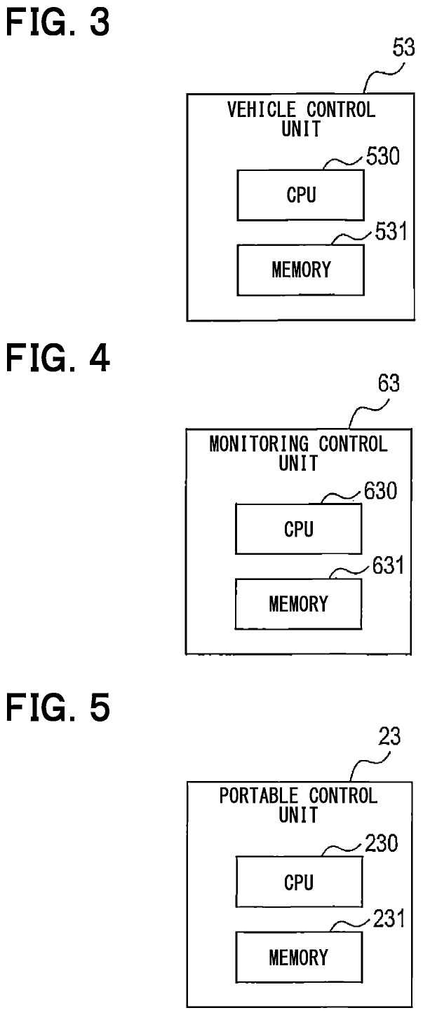

As illustrated in FIG. 3, the vehicle control unit 53 is an electronic control unit mainly configured by a microcomputer including a CPU 530 and a memory 531, such as a ROM and a RAM. Various functions of the microcomputer are implemented by the CPU 530 executing a program stored in a non-transitory tangible storage medium. In this example, the ROM corresponds to the non-transitory tangible storage medium storing the program. By executing the program, a method corresponding to the program is executed. Note that partial or all of the functions executed by the CPU 530 may be implemented by a hardware circuit, such as one or more ICs. In addition, the number of microcomputers configuring the vehicle control unit 53 may be one or more.

As illustrated in FIG. 1, the vehicle control unit 53 includes function blocks, such as a BLE communication unit 55, a communication control unit 56, a target driving unit 57, and a position specifying unit 58. These function blocks are implemented by the CPU 530 executing program code stored in the non-transitory tangible storage medium.

The BLE communication unit 55 performs short-range wireless communication with the smart device 2 via the main antenna 51 and the vehicle transceiver 52 using a communication method conforming to BLE. The BLE communication unit 55 executes a vehicle communication process to be described later.

BLE communication adopts a well-known frequency hopping technique. For example, communication is performed by changing communication channel to be used among multiple channels (for example, 37 channels). The multiple channels are obtained by dividing a frequency of 2.4 GHz band into 2 MHz widths. The predetermined number (for example, 5 channels) of communications channels to be used in the BLE communication are changed based on information (hereinafter referred to as frequency information) determined at the time of connection establishment. The frequency information indicates the predetermined number of channels.

Based on the frequency information, the vehicle device 4 and the smart device 2 perform transmission and reception with one another using the same channel. The channel is switched to the next channel in response to elapse of a predetermined interval period Ti from the start of transmission of communication frame from the vehicle device 4. In other words, in BLE communication, communication is required to completed within each period of frequency hopping (that is, interval period Ti).

The vehicle transceiver 52 generates a transmission signal to be transmitted to the smart device 2 by modulating a transmission carrier wave of the channel using the frequency information for the signal indicating the communication frame output from the BLE communication unit 55, and transmits the modulated transmission signal from the main antenna 51. For example, the vehicle transceiver 52 changes a passband of frequency filter based on the frequency information, and then receives the signal transmitted from the smart device 2 using the communication channel.

For example, the vehicle transceiver 52 demodulates a signal indicating the communication frame from the reception signal, generates data indicating the communication frame, and inputs the data to the BLE communication unit 55. The vehicle transceiver 52 may have a function of restoring data indicating a communication frame before encryption from data indicating an encrypted communication frame.

The communication control unit 56 performs a control related to BLE communication, more specifically, control related to a communication frame to be transmitted to the smart device 2. For example, the communication control unit 56 determines whether to divide the communication frame when transmitting data included in the communication frame, and determines whether to notify the BLE communication unit 55 of the presence or absence of data, which is generated by the frame division and to be transmitted to the smart device.

The target driving unit 57 drives the target device 7 when the smart device 2 approaches within the predetermined range from the vehicle 3. For example, as illustrated in FIG. 2, the target driving unit 57 determines whether the position of smart device 2 specified by the position specifying unit 58 is in the vehicle compartment (for example, in a region Aa). When the target driving unit determines that the position of smart device 2 is in the vehicle compartment, the target driving unit 57 starts or stops the engine of vehicle 3 as the target device 7 in response to an instruction from the smart device 2 (that is, control the engine in accordance with the instruction).

The target driving unit 57 determines whether the position of smart device 2 specified by the position specifying unit 58 is in the vicinity of the right door (for example, in a region Ab). When the target driving unit determines that the position of smart device 2 is in the vicinity of the right door, the target driving unit 57 unlocks or locks the right door as the target device 7 in response to an instruction from the smart device 2.

The vehicle device 4 determines whether the position of smart device 2 specified by the position specifying unit 58 is in the vicinity of the left door (for example, in a region Ac). When the target driving unit determines that the position of smart device 2 is in the vicinity of the left door, the target driving unit 57 unlocks or locks the left door as the target device 7 in response to an instruction from the smart device 2.

The vehicle device 4 determines whether the position of smart device 2 specified by the position specifying unit 58 is in the vicinity of the rear door (for example, in a region Ad). When the target driving unit determines that the position of smart device 2 is in the vicinity of the rear door, the target driving unit 57 unlocks or locks the rear door as the target device 7 in response to an instruction from the smart device 2.

The position specifying unit 58 specifies the position of smart device 2 based on the received signal strength of signal, which is transmitted from the smart device 2 and input to each monitoring device 6 (specifically, a determination unit 59 to be described later). The position specifying unit 58 executes a position specifying process to be described later.

### (Monitoring Device)

As described above, the sub-antenna 61 is an antenna for receiving a signal of the 2.4 GHz band, which is used for BLE communication. Therefore, a signal under the BLE communication between the vehicle device 4 (specifically, the BLE communication unit 55) and the smart device 2 is also received by each sub-antenna 61 (that is, 61a, 61b, 61c, and 61d) mounted on the vehicle 3.

It can be said that a signal of BLE communication between the vehicle device 4 and the smart device 2 can be received by the monitoring device 6 (that is, the sub-antenna 61, the monitoring receiver 62, and the monitoring control unit 63) when the above-described frequency information is known in advance. In other words, “can be received” may be interpreted as “can be monitored or can be intercepted.”

For example, the monitoring receiver 62 changes the passband of frequency filter based on the above-described frequency information, receives the signal transmitted from the smart device 2 using the communication channel, and demodulates the signal indicating the communication frame from the received signal. The monitoring control unit 63 generates data indicating the communication frame from the signal indicating the communication frame, and outputs the data to the monitoring control unit 63. The data mentioned here may be, for example, data represented by a binary number.

In the establishment of connection between the vehicle device 4 and the smart device 2, the frequency information may be output from the vehicle control unit 53 (for example, the BLE communication unit 55) to the monitoring device 6 (for example, the monitoring receiver 62 and the monitoring control unit 63), The monitoring receiver 62 is configured to change the passband of frequency filter for each interval period Ti based on the frequency information. The start time of interval period Ti may be notified from the vehicle control unit 53 (for example, the BLE communication unit 55) to the monitoring control unit 63 and the monitoring receiver 62.

The monitoring receiver 62 detects the strength of signal received by the sub-antenna 61. Specifically, the monitoring receiver 62 generates a received signal strength indicating the strength of received signal, which is represented by an analog signal such as a voltage value. Then, the monitoring receiver 62 outputs the received signal strength signal, which indicates the strength of received signal, to the monitoring control unit 63 (that is, the determination unit 59 to be described later).

### (Monitoring Control Unit)

As illustrated in FIG. 4, the monitoring control unit 63 is an electronic control unit mainly configured by a microcomputer including a CPU 630 and a memory 631, such as a ROM and a RAM, similarly to the vehicle control unit 53 described above. Various functions of the microcomputer are implemented by the CPU 630 executing a program stored in a non-transitory tangible storage medium. In this example, the ROM corresponds to the non-transitory tangible storage medium storing the program. By executing the program, a method corresponding to the program is executed. Note that partial or all of the functions executed by the CPU 630 may be implemented by a hardware circuit, such as one or more ICs. The number of microcomputers configuring the monitoring control unit 63 may be one or more.

As illustrated in FIG. 1, the monitoring control unit 63 has a function as the determination unit 59. The determination unit 59 executes a transmission source determination process, which will be described later. The determination unit 59 specifies a signal whose transmission source is the smart device 2, among multiple reception signals received via the sub-antenna 61. Then, the determination unit 59 inputs a reception strength signal indicating the strength of received signal, which is specified as transmitted from the smart device 2, to the vehicle control unit 53 (that is, the position specifying unit 58).

In the present embodiment, the monitoring control unit 63 acquires the reception strength signal from the monitoring receiver 62 at predetermined intervals, and stores the reception strength signal (that is, the reception strength indicated by the reception strength signal) in the memory 631. For example, the monitoring control unit 63 may overwrite and store the reception strength signal in the memory 631 every time the reception strength signal is acquired.

### 1-2. Smart Device

The smart device 2 is a portable device (i.e. carried by a user). The smart device 2 may be, for example, a well-known smartphone. The smart device 2 executes an application of the smart entry start system. When the smart device 2 is located within the predetermined range from the vehicle 3 (that is, the sub-antenna 61 installed in the vehicle 3) while the application is in execution state, the smart device 2 outputs an instruction to the vehicle device 4 by BLE communication in response to an input operation made by the user.

The instructions include instructions to lock and unlock each door of the vehicle 3, start and stop the engine, and the like. As described above, in the vehicle 3, locking and unlocking of each door, start and stop of engine, and the like are executed according to the instructions from the smart device 2.

The smart device 2 includes a portable antenna 21, a portable transceiver 22, and a portable control unit 23. The portable antenna 21 receives a signal within the 2.4 GHz band used for BLE communication. The portable transceiver 22 is configured in the same manner as the vehicle transceiver 52 described above. The portable transceiver 22 generates a transmission signal to be transmitted to the vehicle device 4 by modulating a transmission carrier wave of the channel using the frequency information for the signal indicating the communication frame of the BLE communication, and transmits the modulated transmission signal from the portable antenna 21.

For example, the portable transceiver 22 changes the passband of frequency filter based on the frequency information, receives the signal transmitted from the vehicle device 4 using the communication channel, demodulates the received signal, and inputs data indicating the communication frame to the portable control unit 23.

As shown in FIG. 5, the portable control unit 23 is an electronic control unit mainly configured by a microcomputer including a CPU 230 and a memory 231, such as a ROM and a RAM, similarly to the vehicle control unit 53 and the monitoring control unit 63 described above. Various functions of the microcomputer are implemented by the CPU 230 executing a program stored in a non-transitory tangible storage medium. In this example, the ROM corresponds to the non-transitory tangible storage medium storing the program. By executing the program, a method corresponding to the program is executed. Note that partial or all of the functions executed by the CPU 230 may be configured as a hardware circuit by one or more ICs or the like. The number of microcomputers configuring the portable control unit 23 may be one or more. For example, the program of the above-described application may be stored in the memory 231.

As illustrated in FIG. 1, the portable control unit 23 has a function as a communication unit 24. The communication unit 24 executes a portable communication process to be described later. As illustrated in FIG. 1, the communication unit 24 performs short-range wireless communication with the vehicle device 4 via the portable antenna 21 and the portable transceiver 22 using a communication method conforming to BLE.

### 1-3. Position of Smart Device

### (Position Estimation)

In the BLE communication, after the connection is established, a communication frame from the vehicle device 4 to the smart device 2 is paired with a communication frame from the smart device 2 to the vehicle device 4, and communication of the pair frames (hereinafter, referred to as pair frame) is repeated. The communication frame referred to here is a communication frame indicating data packet.

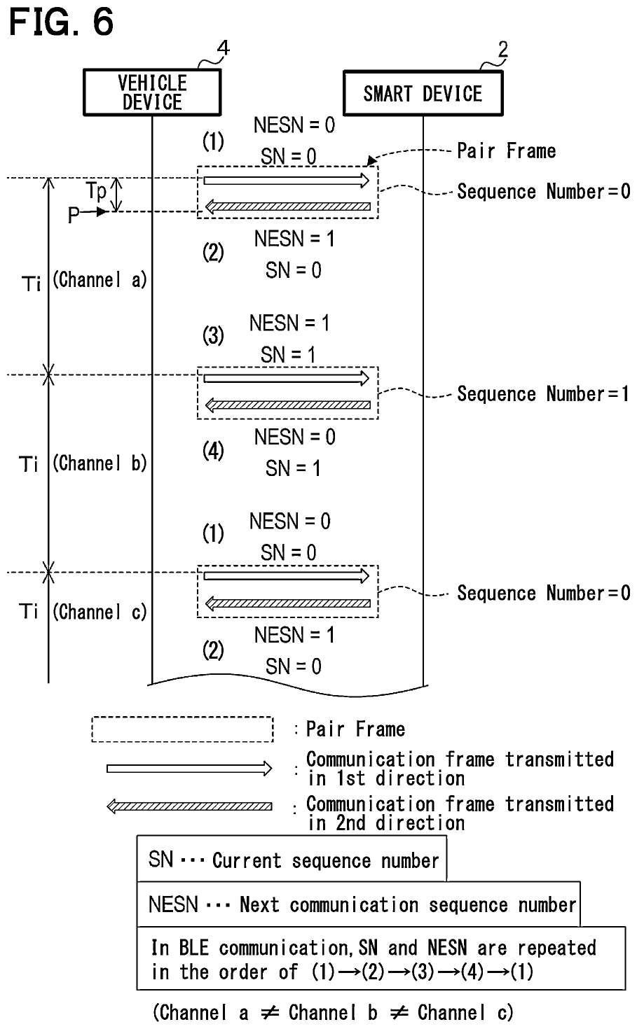

In the pair frame, first, a communication frame is transmitted from the vehicle device 4 to the smart device 2, and then a communication frame is transmitted from the smart device 2 to the vehicle device 4. For example, in FIG. 6, communication frames surrounded by a dotted line, that is, a communication frame from the vehicle device 4 to the smart device 2 indicated by a white arrow and a communication frame from the smart device 2 to the vehicle device 4 indicated by a hatched arrow correspond to one pair frame.

As described above, in BLE communication, communication is performed by the frequency hopping method. For example, communication is performed using the same frequency (that is, the same channel) until elapse of a predetermined interval period Ti from start of transmission of a communication frame from the vehicle device 4. After elapse of the predetermined interval period, communication is performed using the next different channel until elapse of the interval period Ti from start of transmission of the communication frame from the vehicle device 4.

Since the interval period Ti is set in advance, it is possible to estimate the time at which the vehicle device 4 receives the communication frame from the smart device 2 while the communication is being performed between the vehicle device 4 and the smart device 2. The signal received by the sub-antenna 61 at the reception time of communication frame is estimated to be a signal transmitted from the smart device 2. For example, it is considered that the position of smart device 2 can be estimated based on the reception strength of signal (that is, the reception strength stored in the memory 631 by the monitoring receiver 62 at the reception time of communication frame). This method of specifying position is known as position detection based on RSSI (that is, the received signal strength of signal transmitted from the smart device 2 and received by the vehicle device). RSSI is an abbreviation for Received Signal Strength Indicator.

It is assumed that, in the interval period Ti, a prediction period Tp in which the communication by the pair frame is assumed to be performed is predicted in advance. For example, the reception strength stored in the memory 631 by the determination unit 59 at the time P closest to the end of prediction period Tp is estimated to be the reception strength of signal transmitted from the smart device 2. Accordingly, it is considered that a signal transmitted from the smart device 2 can be estimated and the position of smart device 2 can be detected based on the reception strength of the signal, which is estimated to be transmitted from the smart device 2.

While the communication from the smart device 2 to the vehicle device 4 is being performed, the vehicle device may fail to receive a signal transmitted from the smart device 2 (that is, a situation in which there is no received signal). Examples of the situation in which there is no received signal may include a situation in which a metal product that affects the performance of sub-antenna 61 is located in the vicinity of the sub-antenna 61, a situation in which the sub-antenna 61 is covered by a metal product, or a situation in which an abnormality occurs in the sub-antenna 61.

In this case, the reception strength (that is, the reception strength indicating a signal) stored in the memory 631 at the time P closest to the end of prediction period Tp may be estimated as the reception strength of immediately preceding signal whose transmission source is the vehicle device 4, instead of the signal whose transmission source is the smart device 2.

The signal detected by the determination unit 59 at the time P closest to the end of prediction period Tp is not always a signal whose transmission source is the smart device 2. When such a detection result is used, it may be erroneously determined that the signal is transmitted from the smart device 2 even though the signal is transmitted from the vehicle device 4. Accordingly, the position of smart device 2 may be erroneously detected.

### (Specifying Transmission Source of Reception Signal)

The vehicle device 4 specifies the transmission source of communication frame as follows. As illustrated in FIG. 6, in BLE communication, communication related to one pair frame described above is referred to as one sequence. That is, one sequence includes one communication frame transmitted in the first direction and one communication frame transmitted in the second direction. The first direction is a direction from the vehicle device 4 toward the smart device 2, and the second direction is a direction from the smart device 2 toward the vehicle device 4.

In BLE communication, a number (hereinafter, sequence number) is assigned to each sequence in order to distinguish each sequence (that is, each pair frame) from one another. As the sequence number, for example, two numerical values 0 and 1 represented by one bit may be used. The sequence number is repeatedly assigned to each sequence in order, for example, 0, 1, 0, 1 . . . , at intervals of a quantity of sequence numbers (herein, the quantity of sequence numbers is two corresponding to two numerical values 0 and 1). Thus, different sequence numbers are assigned to at least two successive sequences.

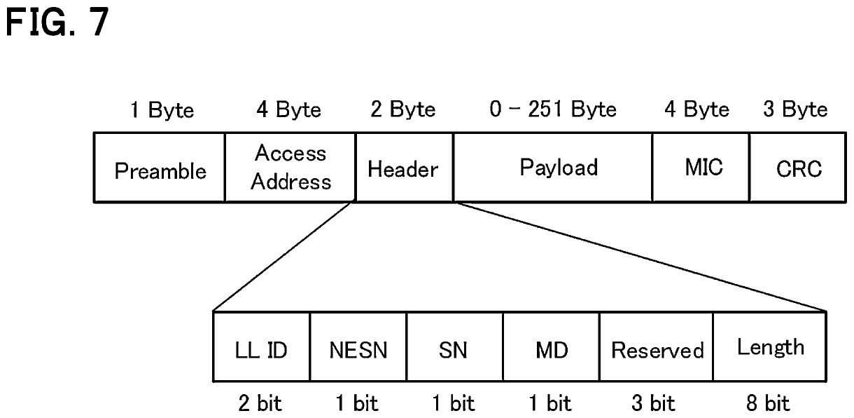

In the communication frame of BLE communication (that is, communication frame of data packet), as illustrated in FIG. 7, NESN and SN are included in a header field. NESN and SN each is represented by one bit. SN indicates a sequence (that is, a pair frame) including a communication frame to be transmitted. NESN indicates a sequence (that is, a pair frame) including a communication frame to be received next time.

The SN is information indicating a pair frame including a communication frame to be transmitted, and may be referred to as current pair frame information. NESN is information indicating a pair frame including a communication frame to be received next time, and may be referred to as next pair frame information. Hereinafter, SN and NESN are also referred to as communication direction information.

The communication direction information is information indicating the communication direction of communication frame included in the pair frame. The communication direction of communication frame refers to a direction in which the communication frame is transmitted from where to where. As described above, one pair frame includes one communication frame transmitted in the first direction and one communication frame transmitted in the second direction. The communication direction information includes SN as the current pair frame information, and includes NESN as the next pair frame information.

As shown in FIG. 6, the communication frame transmitted in the first direction from the vehicle device 4 is always NESN=SN, and the communication frame transmitted in the second direction from the smart device 2 is always NESN≠SN. In this way, whether the transmission direction of the communication frame is the first direction or the second direction is specified by the combination of NESN and NS (that is, determining whether NESN=SN or NESN SN).

In the communication system 1, as described above, the transmission source of communication frame is specified based on the difference between (i) the combination of NESN and NS of the communication frame transmitted in the first direction and (ii) the combination of NESN and NS of the communication frame transmitted in the second direction. Hereinafter, the communication direction information indicating the first direction (that is, NESN and SN satisfying NESN=NS) is also referred to as first direction information. The communication direction information indicating the second direction (that is, NESN and SN satisfying NESNNS) is also referred to as second direction information.

In the communication frame of BLE communication, the header field is a field that is not encrypted (hereinafter referred to as a non-encrypted field). That is, the communication direction information is included in the unencrypted field of the communication frame.

### (Frame Division)

The upper limit of the amount of data that can be transmitted by one communication frame is predetermined. In BLE communication, when data having a size exceeding the upper limit of data amount is transmitted, frame division is executed. In the frame division, when data having a size exceeding the upper limit data amount is transmitted, the transmission source device divides the data to be transmitted into multiple pieces of data each having a size equal to or smaller than the upper limit data amount. Then, the transmission source device transmits multiple communication frames including respective divided data piece.

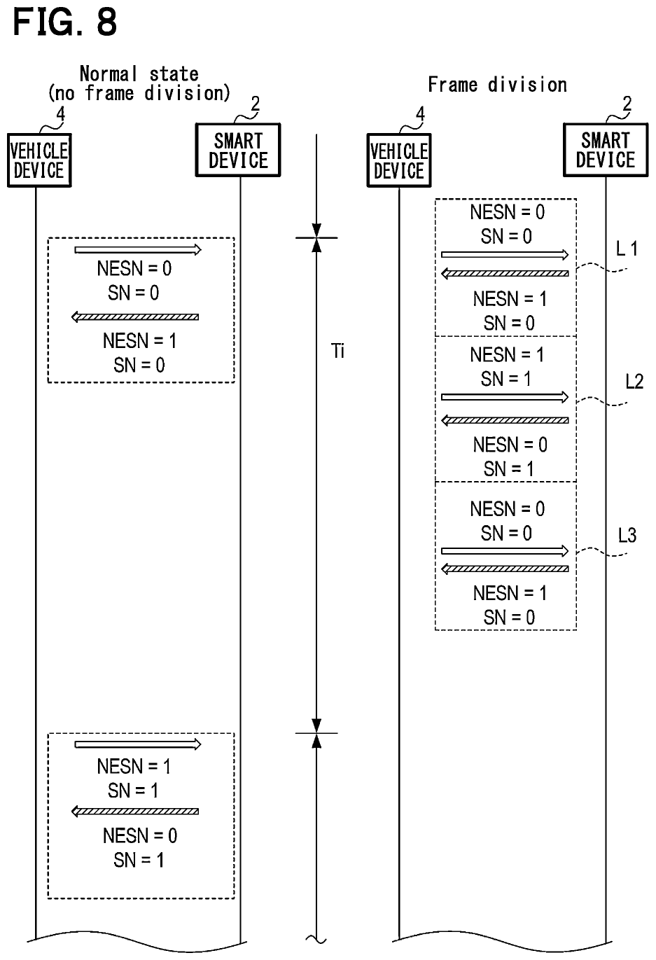

For example, when the amount of data transmitted from the vehicle device 4 exceeds the upper limit of permitted data amount, the data is divided into multiple pieces (for example, three pieces) and then transmitted. In this case, as illustrated as “Frame division” in FIG. 8, three communication frames in the first direction are transmitted within the interval period Ti, that is, within the same channel. In the smart device 2, a communication frame is transmitted in the second direction in response to each communication frame, which is transmitted from the vehicle device 4 in the first direction. That is, communication is performed by the three pair frames L1 to L3.

When the amount of data to be transmitted from the smart device 2 exceeds the upper limit of data amount, frame division is executed by the smart device in similar manner. The communication based on the divided frames is executed such that the entire divided frames are communicated within the interval period Ti.

When the frame division is executed, the same NESN and NS as described above are included in the header field. That is, even when the frame division is executed, the communication direction of communication frame and the transmission source of communication frame can be specified based on the combination of NESN and NS in a similar manner as described above.

The MD included in the header field is one bit information. When the MD is set to 1, it indicates that there is a communication frame to be transmitted next time from the transmission source device. When the MD is set to 0, it indicates that there is no communication frame to be transmitted next time from the transmission source device. That is, MD=0 indicates a normal state in which frame division is not performed. MD=1 indicates that there is a communication frame to be transmitted next time in a case where frame division is executed.

### 2. Process

### 2-1. Process Executed by Vehicle Device

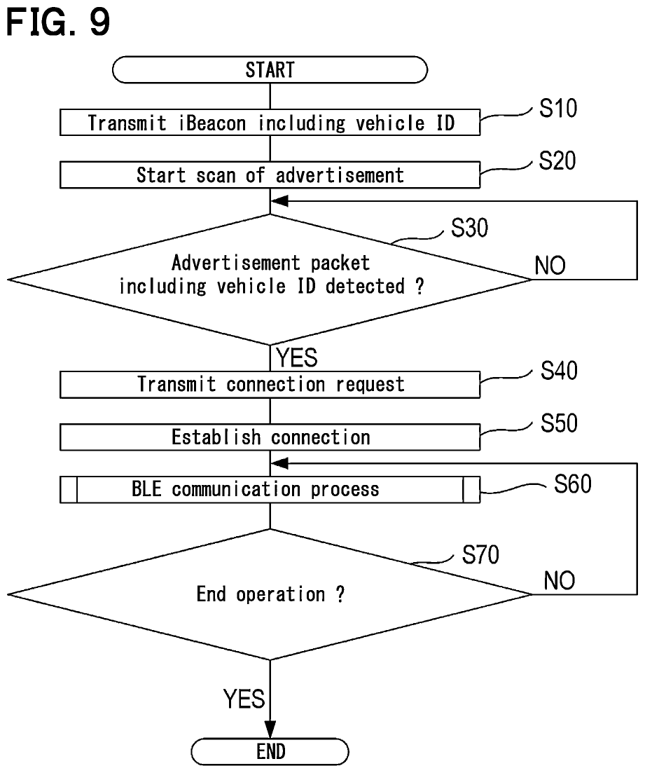

Process executed by the vehicle device 4 will be described with reference to flowcharts of FIG. 9 to FIG. 13.

### (Vehicle Communication Process)

A vehicle communication process executed by the vehicle control unit 53 (specifically, the BLE communication unit 55) of the vehicle device 4 will be described with reference to flowcharts illustrated in FIG. 9 to FIG. 11. The vehicle communication process can be repeatedly executed (for example, constantly).

In S10, the BLE communication unit 55 transmits an iBeacon (registered trademark) including vehicle information capable of identifying the vehicle 3. For example, the vehicle information may be information (that is, a vehicle ID) capable of identifying each vehicle. As will be described later, when the smart device 2 receives the iBeacon including the registered vehicle ID, the smart device 2 transmits an advertisement packet including a portable ID capable of identifying the smart device 2.

In subsequent S20, the BLE communication unit 55 starts scanning for an advertisement packet. That is, the BLE communication unit 55 starts receiving the advertisement packet by the main antenna 51 and the vehicle transceiver 52.

Next, in S30, the BLE communication unit 55 determines whether an advertisement packet including the portable ID (hereinafter, also referred to as a target advertisement packet) is detected. The portable ID is information capable of identifying a smart device (that is, the smart device 2) registered in advance (that is, associated with the vehicle 3 in advance). The BLE communication unit 55 determines whether the portable ID is stored in the advertisement packet, which is received by the main antenna 51 and the vehicle transceiver 52. When the target advertisement packet is not detected, the BLE communication unit 55 waits, by repeating the process in S30, until the target advertisement packet is detected. When the target advertisement packet is detected, the BLE communication unit 55 proceeds to S40.

In S40, the BLE communication unit 55 transmits a connection request to the smart device 2 that has transmitted the target advertisement packet.

In subsequent S50, the BLE communication unit 55 performs pairing with the smart device 2 that has transmitted the target advertisement packet in accordance with the specification of BLE standard. After the pairing is completed, the BLE communication unit establishes a connection of short-range wireless communication with a communication method conforming to BLE.

In S60, the BLE communication unit 55 executes BLE communication with the smart device 2 with which the connection is established. The BLE communication here refers to transmission and reception of data packet. The BLE communication process executed by the BLE communication unit 55 will be described later.

In subsequent S70, the BLE communication unit 55 determines whether an end operation is performed for ending the BLE communication with the smart device 2, with which the connection has been established. Examples of the end operation include an operation of turning off the BLE communication in the smart device 2 that has established the connection with the vehicle device, and an operation of ending the application installed in the smart device 2 (that is, the application of smart entry start system). Examples of the end operation may include moving the smart device 2 out of the connection area.

In response to determining that no end operation is detected, the BLE communication unit 55 returns to S60 and continues the BLE communication with the smart device 2 with which the connection is established. In response to determining that an end operation is detected, the BLE communication unit 55 ends the vehicle communication process.

(BLE Communication Process executed by Vehicle Device)

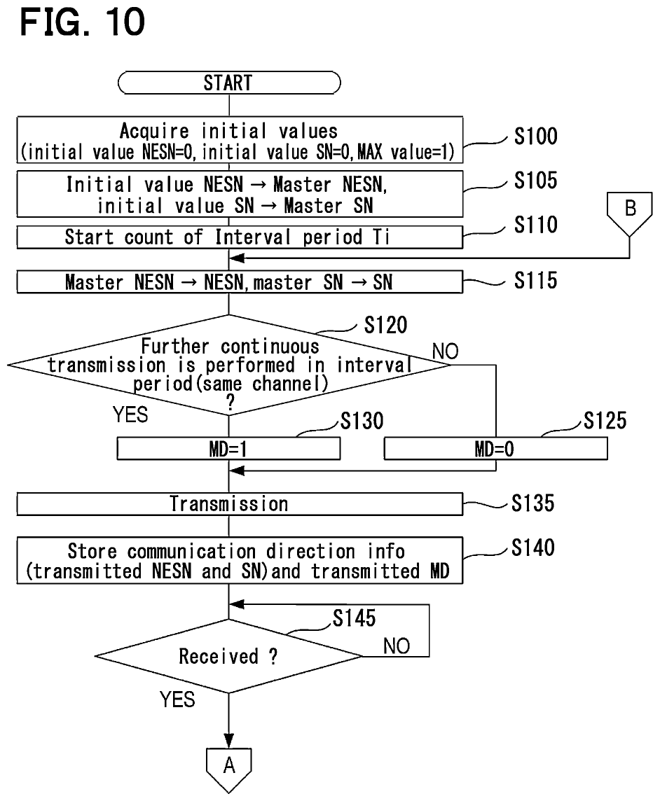

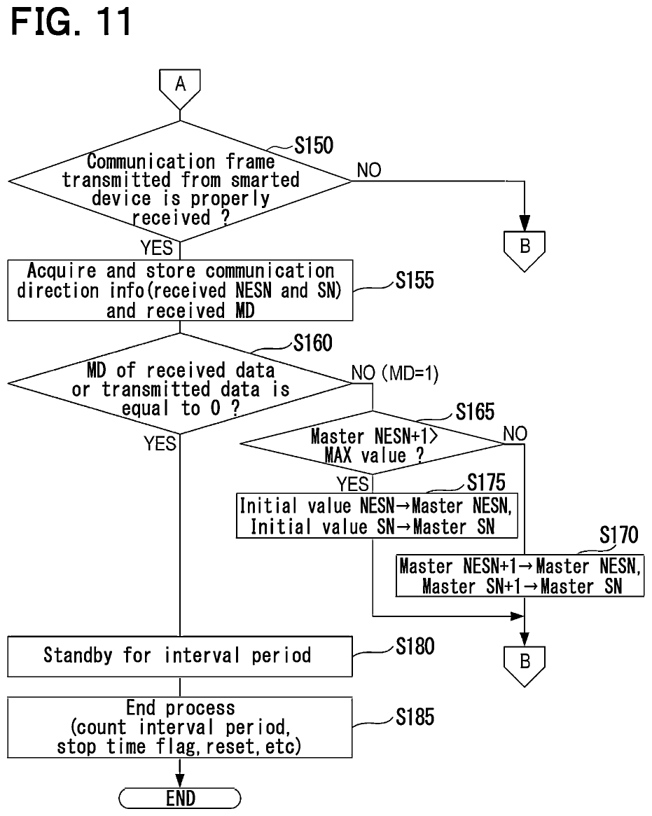

Next, the BLE communication process executed by the vehicle control unit 53 (that is, the BLE communication unit 55) in S60 will be described with reference to FIG. 10 and FIG. 11.

In S100 to S110, the BLE communication unit 55 performs initial setting.

In S100, the BLE communication unit 55 sets an initial value of NESN (hereinafter, also referred to as an initial value NESN) and an initial value of SN (hereinafter, also referred to as an initial value SN). In addition, the BLE communication unit 55 sets a maximum value (hereinafter referred to as a MAX value), which is settable as values of NESN and SN. In BLE communication, the initial values of NESN and SN are 0, and the MAX value is 1. The initial values of NSEN and SN, and the MAX value may be stored in the memory 531 in advance.

In subsequent S105, the BLE communication unit 55 sets the value of master NESN as the initial value NESN (that is, 0), and sets the value of master SN as the initial value SN (that is, 0). The master NESN is a value set as NESN included in a communication frame whose transmission source is the vehicle device 4, and the master SN is a value set as SN included in a communication frame whose transmission source is the vehicle device 4.

In S110, the BLE communication unit 55 starts a timer for counting the interval period Ti.

In S115 to S130, the BLE communication unit 55 sets NESN, SN, and MD included in the header of the communication frame in accordance with the specification of BLE standard.

For example, in S115, the BLE communication unit 55 sets the value of master NESN as the NESN included in the communication frame whose transmission source is the vehicle device 4, and sets the value of the master SN as the SN included in the communication frame whose transmission source is the vehicle device 4.

In S120, the BLE communication unit 55 determines whether further continuous transmission is to be performed from the vehicle device 4 within the interval period Ti (that is, the same channel). For example, when data is not transmitted by frame division, it is determined that further continuous transmission is not performed. For example, when data is transmitted by frame division and the last data among all the divided data is transmitted, it is determined that further continuous transmission is not performed.

When data is transmitted by frame division and data other than the last one among all the divided data is transmitted, it is determined that further continuous transmission is to be performed. For example, the communication control unit 56 may determine whether to perform the frame division, the order of data piece among entire pieces of data divided by the frame division at the present time (that is, whether the data piece is the last data piece), and the like. Then, based on the determination result by the communication control unit 56, the BLE communication unit can determine whether further continuous transmission is to be performed.

When the BLE communication unit determines that further continuous transmission is not performed, the BLE communication unit 55 proceeds to S125. In S125, the MD is set to, and the process proceeds to S135. When it is determined that further continuous transmission is to be performed, the BLE communication unit 55 proceeds to S130, and sets the MD to 1 in S130. Then, the process proceeds to S135.

In S135, the BLE communication unit 55 also performs setting other than NESN, SN, and MD in the header according to the specification of BLE standard, generates a communication frame, and transmits the generated communication frame via the main antenna 51 and the vehicle transceiver 52.

The communication frame transmitted from the vehicle device 4 in this manner includes the first direction information. The first direction information is communication direction information indicating that the communication direction is the first direction. Specifically, the above-described NESN and SN, which are a combination of NESN and SN having the same value, correspond to the first direction information. The BLE communication unit 55 generates, as the first direction information, communication direction information in which the current pair frame information and the next pair frame information are equal to each other.

In S140, the BLE communication unit 55 stores the communication direction information (that is, NESN and SN) and the MD transmitted in S135 in, for example, the memory 531.

In subsequent S145, the BLE communication unit 55 determines whether a signal is received. When no signal is received, the BLE communication unit 55 waits until a reception of signal by repeating S145. For example, the BLE communication unit 55 determines that a signal is received when the reception strength of signal received via the main antenna 51 is equal to or greater than a predetermined signal strength threshold value.

For example, the signal threshold strength value may be set to a value larger than the strength of reception signal from the smart device 2 located in a disconnection area illustrated in FIG. 2 and smaller than the strength of reception signal from the smart device 2 located in a connection area illustrated in FIG. 2. The vehicle transceiver 52 may be configured to detect the reception strength of a signal received via the main antenna 51.

In S150, the BLE communication unit 55 determines whether a communication frame whose transmission source is the smart device 2 is properly received. For example, the BLE communication unit 55 may determine that the communication frame whose transmission source is the smart device 2 is received when an access address of the received communication frame matches an access address determined at the time of connection establishment. The access address is included in an unencrypted field the communication frame.

The proper reception refers to a reception without error and retransmission request. For example, when the CRC included in the received communication frame matches the CRC calculated based on the content of received communication frame, the BLE communication unit 55 may determine that the communication frame has been received without error. In addition, the BLE communication unit 55 may determine that there is no retransmission request in a case where a retransmission request for requesting retransmission of a transmitted communication frame is not included in a received communication frame (for example, a payload or the like).

In a case where the BLE communication unit determines that the communication frame whose transmission source is the smart device 2 is not properly received, the process returns to S115, and the process repeats from S115 and subsequent thereof. That is, the same communication frame as the communication frame transmitted immediately before is transmitted again. When the BLE communication unit determines that the communication frame whose transmission source is the smart device 2 is properly received, the process proceeds to S155.

In S155, the BLE communication unit 55 stores, in the memory 531, NESN, SN, and MD included in the communication frame, which is transmitted from the smart device 2 and received in S150.

In S160, the BLE communication unit 55 determines, based on the information stored in the memory 531, whether the MD included in the header field of the communication frame transmitted from the smart device 2 or the communication frame transmitted from the vehicle device is equal to 0. The BLE communication unit 55 proceeds to S180 in response to determining that the MD is equal to 0. The BLE communication unit 55 proceeds to S165 in response to determining that the MD is equal to 1.

In S165, the BLE communication unit 55 determines whether the value of master NESN+1, that is, the NESN of the communication frame to be transmitted next from the vehicle device 4 is larger than the MAX value.

In response to determining that the value of master NESN+1 is equal to or less than the MAX value, the BLE communication unit 55 proceeds to the S170. In S170, the BLE communication unit 55 sets the master NESN+1 as the value of new master NESN, and sets the master SN+1 as the value of new master SN. Then, the BLE communication unit 55 returns to S115. Accordingly, in S115, NESN=1 and SN=1 are set.

In response to determining that the value of master NESN+1 is larger than the MAX value, the BLE communication unit 55 proceeds to S175. In S175, the BLE communication unit 55 initializes the values of master NESN and the master SN. That is, the master NESN is set to the initial value NESN (that is, 0), and the master SN is set to the initial value SN (that is, 0). Then, the BLE communication unit 55 returns to S115. Accordingly, in S115, NESN=0 and SN=0 are set.

In S180, the BLE communication unit 55 waits until the count value of the timer for counting the interval period Ti reaches the interval period Ti. The interval period Ti may be set to, for example, several tens to several hundreds of milliseconds (msec).

In subsequent S185, the BLE communication unit 55 stops the timer for counting the interval period Ti. Then, the BLE communication unit 55 ends the BLE communication process.

### (Transmission Source Determination Process)

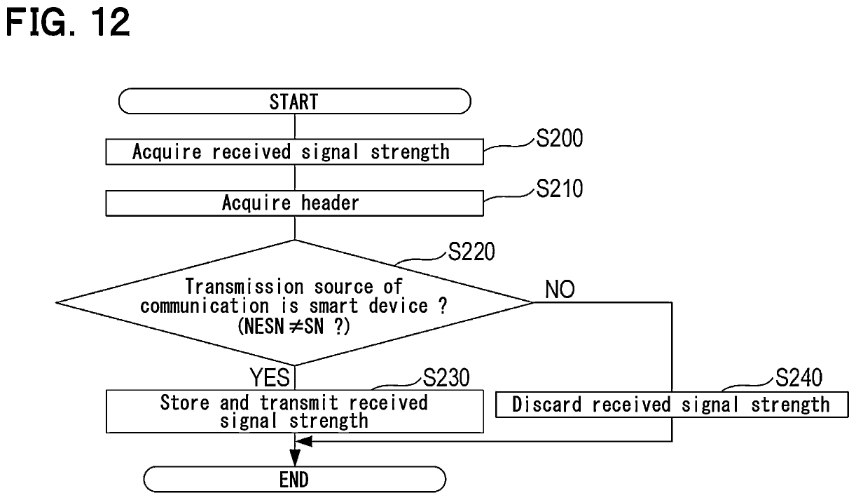

The following will describe a transmission source determination process executed by each monitoring control unit 63 (that is, each determination unit 59 in the corresponding monitoring control unit 63) with reference to the flowchart of FIG. 12.

The determination unit 59 repeatedly executes the transmission source determination process at predetermined intervals.

First, in S200, the determination unit 59 acquires the reception strength of signal (specifically, the reception strength signal) received by the sub-antenna 61 and output from the monitoring receiver 62.

In S210, the determination unit 59 acquires the data indicating the header field from the data, which indicates the communication frame and is output from the monitoring receiver 62.

In S220, the determination unit 59 determines whether the transmission source of communication frame received by the sub-antenna 61 is the smart device 2. When the communication frame received by the sub-antenna 61 includes second direction information, which corresponds to the communication direction information and indicates that the communication direction is the second direction, the determination unit 59 determines that the transmission source of the communication frame is the smart device 2.

Specifically, the determination unit 59 determines whether NESN and SN included in the header field are different from one another (that is, NESN #SN). In the present embodiment, being different from one another (that is, being inconsistent) means NESN=1 and SN=0, or NESN=0 and SN=1.

When the NESN and the SN included in the header field are different from one another, the determination unit 59 determines that the transmission source of the communication frame is the smart device 2, and proceeds to S230. Then, the determination unit stores the reception strength signal acquired in S200 in the memory 631. The determination unit 59 may store the reception strength signal by overwriting the reception strength signal stored in the memory 631. Then, the determination unit 59 outputs the reception strength signal acquired in S200 to the position specifying unit 58. Then, the determination unit 59 ends the transmission source determination process.

When the NESN matches with SN included in the header field, the determination unit 59 determines that the transmission source of the communication frame is not the smart device 2 (that is, the transmission source is the vehicle device 4), and the process proceeds to S240. In the present embodiment, NESN matches with SN means having the same value, such as NESN=0 and SN=0, or NESN=1 and SN=1.

In S240, the determination unit 59 discards the reception strength signal acquired in S200. That is, the determination unit 59 stores the reception strength signal acquired in S200 in the memory 631, but does not output the reception strength signal to the position specifying unit 58. The determination unit 59 may store the reception strength signal by overwriting the reception strength signal stored in the memory 631. Then, the determination unit 59 ends the transmission source determination process.

### (Position Specifying Process)

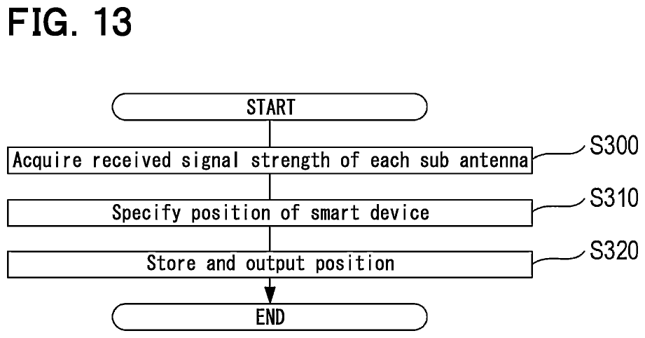

The following will describe a position specifying process executed by the vehicle control unit 53 (that is, the position specifying unit 58) with reference to a flowchart shown in FIG. 13.

The position specifying unit 58 starts the position specifying process when the determination unit 59 determines that the transmission source of the communication frame received by the sub-antenna 61 is the smart device 2. For example, the determination unit 59 may be configured to set a flag in response to determining that the transmission source of the communication frame received by the sub-antenna 61 is the smart device 2. The position specifying unit 58 may start the position specifying process when the flag is set.

First, in S300, the position specifying unit 58 acquires the reception strength of communication frame transmitted from the smart device 2 in each sub-antenna 61. In the present embodiment, the position specifying unit 58 acquires the reception strength transmitted from each determination unit 59 (that is, the determination units 59a, 59b, 59c, and 59d). That is, the position specifying unit 58 acquires the reception strength when each determination unit 59 specifies that the transmission source of the communication frame received by the sub-antenna 61 is the smart device 2.

Next, in S310, the position specifying unit 58 detects the position of smart device 2. For example, the position specifying unit 58 detects a distance from each sub-antenna 61 to the smart device 2 based on the reception strength signal from each determination unit 59. Then, the position specifying unit 58 specifies the position of smart device 2 by using, for example, a triangulation method based on the distance from each sub-antenna 61 to the smart device 2. The position of the smart device 2 may be represented by latitude and longitude, or may be represented by relative coordinates with a predetermined portion of the vehicle 3 as an origin.

Subsequently, in S320, the position specifying unit 58 stores the specified position of smart device 2 in the memory 531, and outputs the specified position to the target driving unit 57. Then, the position specifying unit 58 ends the position specifying process.

### 2-2. Process Executed by Smart Device

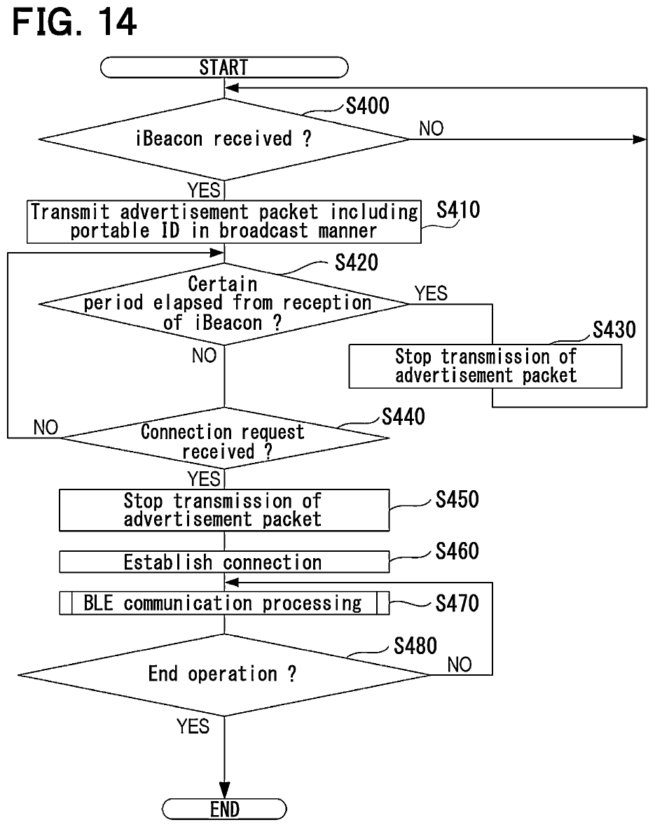

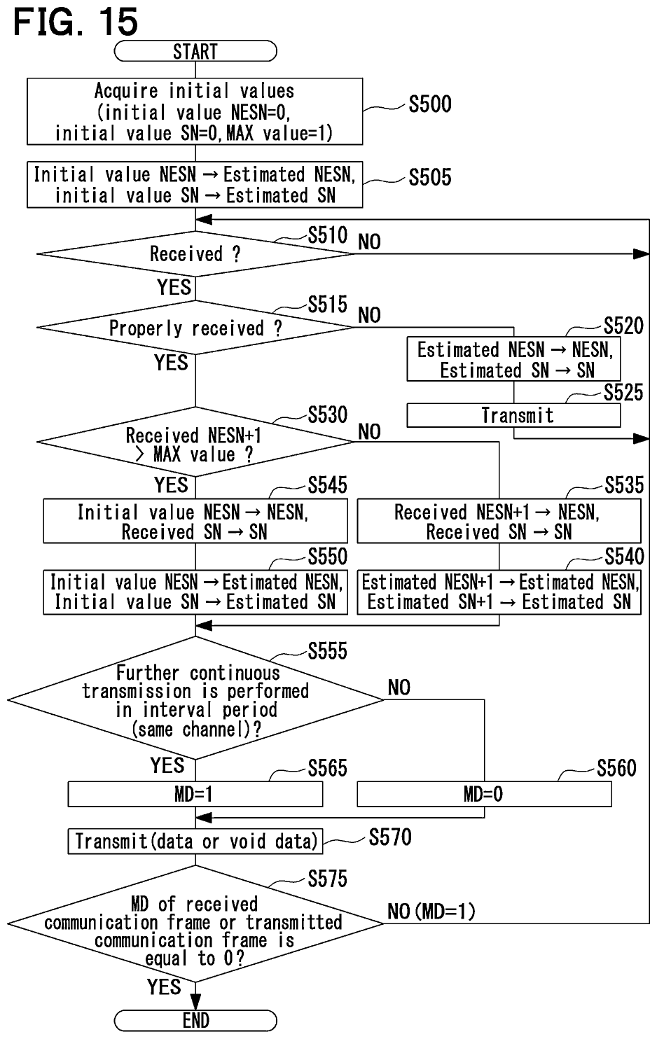

The portable communication process executed by the smart device 2 will be described with reference to the flowcharts of FIG. 14 and FIG. 15.

### (Portable Communication Process)

For example, the portable communication process executed by the portable control unit 23 (that is, the communication unit 24) of the smart device 2 is repeatedly executed, for example, while the application of the smart entry start system is in activated state in the smart device 2.

In S400, the communication unit 24 determines whether the iBeacon including the vehicle information (that is, the vehicle ID) capable of identifying the vehicle (that is, the vehicle 3) registered in advance (that is, associated with the smart device 2 in advance) is received. When the iBeacon including the vehicle ID is not detected, the communication unit 24 waits, by repeating $400, until the iBeacon including the vehicle ID is detected. In response to detecting the iBeacon including the vehicle ID, the communication unit 24 proceeds to S410.

In S410, the communication unit 24 broadcasts the advertisement packet including the portable ID via the portable transceiver 22 and the portable antenna 21. The portable ID is information capable of identifying the smart device 2.

Next, in S420, the communication unit 24 determines whether a certain period has elapsed since the iBeacon including the vehicle ID is received in S400. In response to determining that the certain period has elapsed, the communication unit 24 proceeds to S430. In S430, the communication unit stops the transmission of advertisement packet, and then returns to S400. Then the process is repeated from S400. In response to determining that the certain period has not yet elapsed, the communication unit 24 proceeds to S440.

In S440, the communication unit 24 determines whether a connection request has been received. In S440, when the communication unit 24 has not received the connection request, the communication unit 24 returns to S420 and repeats the process from S420. In S440, when the communication unit 24 receives the connection request, the process proceeds to S450.

In S450, the communication unit 24 stops the transmission of advertisement packet.

In S460, the communication unit 24 performs pairing with the vehicle device 4 that has transmitted the connection request in accordance with the specification of BLE standard. After the pairing is completed, the communication unit 24 establishes a connection of short-range wireless communication with a communication method conforming to BLE.

In S470, the communication unit 24 performs BLE communication with the vehicle device 4 with which the connection is established. The BLE communication executed by the communication unit 24 will be described later.

In S480, the communication unit 24 determines whether an end operation is made for ending the BLE communication with the vehicle 3 (that is, the vehicle device 4) with which the connection is established. Examples of the end operation include an operation of turning off the BLE communication in the smart device 2, an operation of ending the application installed in the smart device 2, and an operation of moving the smart device 2 out of the connection area. In response to determining that there is no end operation, the communication unit 24 returns to S470 and continues the BLE communication with the vehicle 3 (that is, the vehicle device 4) with which the connection is established.

In response to determining that the end operation is performed, the communication unit 24 ends the portable communication process.

### (BLE Communication Process Executed by Smart Device)

The following will describe the BLE communication process executed by the communication unit 24 of the portable control unit 23 in S470 of the portable communication process with reference to FIG. 15.

In S500 to S510, the communication unit 24 performs initial setting.

For example, in S500, the communication unit 24 sets an initial value of NESN (hereinafter, also referred to as an initial value NESN) and an initial value of SN (hereinafter, also referred to as an initial value SN). In addition, the BLE communication unit 55 sets a maximum value (hereinafter referred to as a MAX value), which is settable as values of NESN and SN. In BLE communication, the initial values of NESN and SN are set to 0, and the MAX value is set to 1. The initial values of NESN and SN, and the MAX value may be stored in the memory 231 in advance.

In subsequent S505, the communication unit 24 sets the value of estimated NESN as the initial value NESN (that is, 0), and sets the value of estimated SN as the initial value SN (that is, 0). The estimated NESN is a value of NESN estimated to be set as NESN included in a received communication frame whose transmission source is the vehicle device 4 (that is, the communication frame transmitted from the vehicle device 4 to the smart device 2). The estimated SN is a value of SN estimated to be set as SN included in a received communication frame, which has the vehicle device 4 as the transmission source.

In subsequent S510, the communication unit 24 determines whether a signal is received. When no signal is received, the communication unit 24 waits until reception of a signal by repeating S510. For example, the communication unit 24 may determine a signal is received when the reception strength of signal received via the portable antenna 21 is equal to or greater than a predetermined signal strength threshold.

Next, in S515, the communication unit 24 determines whether the communication frame whose transmission source is the vehicle device 4 is properly received. The proper reception refers to a reception without error and retransmission request.

In response to determining that the communication frame whose transmission source is the vehicle device 4 is not properly received, the communication unit 24 proceeds to S520. In S520, the communication unit 24 sets the value of estimated NESN as the NESN included in the communication frame whose transmission source is the smart device 2, and sets the value of estimated SN as the SN included in the communication frame whose transmission source is the smart device 2. At this time, MD is set to 0.

In subsequent S525, the communication unit 24 sets the remaining header field other than NESN, SN, and MD in accordance with the specification of BLE standard, and generates a communication frame (that is, a communication frame of data packet). The communication unit 24 transmits the generated communication frame via the portable antenna 21 and the portable transceiver 22, and returns to S510.

In response to determining that the communication frame having the vehicle device 4 as the transmission source is properly received, the communication unit 24 stores NESN, SN, and MD included in the received communication frame in the memory 231, and proceeds to S530. Hereinafter, NESN, SN, and MD included in the received communication frame are also referred to as received NESN, received SN, and reception MD.

In S530, the communication unit 24 determines whether the value of received NESN+1, that is, the NESN of communication frame estimated to be transmitted from the vehicle device 4 next time is larger than the MAX value.

In response to determining that the value of received NESN+1 is equal to or less than the MAX value, the communication unit 24 proceeds to S535. In S535, the communication unit 24 sets the received NESN+1 as a new NESN value, and sets the received SN+1 as a new SN value. Accordingly, in S535, for example, NESN=1 and SN=1 are set. In S540, the communication unit 24 sets the estimated NESN+1 as a new estimated NESN, and sets the estimated SN+1 as a new estimated SN. Thus, in S540, for example, estimated NESN=1 and estimated SN=1 are set. Then, the communication unit 24 proceeds to S555.

In response to determining that the value of received NESN+1 is larger than the MAX value, the communication unit 24 proceeds to S545. In S545, the communication unit 24 initializes the values of NESN and SN. That is, NESN is set to the initial value NESN (that is, 0), and SN is set to the initial value SN (that is, 0). Subsequently, in S550, the communication unit 24 initializes the estimated NESN and the estimated SN. That is, the estimated NESN is set to the initial value NESN (that is, 0), and the estimated SN is set to the initial value SN (that is, 0). Then, the communication unit 24 proceeds to S555.

In S555, the communication unit 24 determines whether the smart device 2 further performs continuous transmission in the same channel. For example, when data to be transmitted from the smart device 2 is divided by frame division and the data to be transmitted is not the last data piece generated by the frame division, the communication unit may determine that further continuous transmission is to be performed in the same channel.

When the frame division is not performed or when the data piece to be transmitted is generated by the frame division but not the last data piece generated by the frame division, the communication unit may determine that further continuous transmission is not necessarily to be performed in the same channel.

In response to determining that further continuous transmission is not necessary, the communication unit 24 proceeds to S560, and sets the MD to 0 in S560. Then, the process proceeds to S570. In response to determining that further continuous transmission is to be performed, the communication unit 24 proceeds to S565, and sets MD to 1 in S565. Then, the process proceeds to S570.

In subsequent S570, the communication unit 24 also performs setting of remaining data other than NESN, SN, and MD in the header field according to the specification of BLE standard, generates a communication frame, and transmits the generated communication frame via the portable antenna 21 and the portable transceiver 22. The communication unit 24 stores the values of NESN, SN, and MD included in the transmitted communication frame in the memory 231.

The communication frame transmitted from the smart device 2 in the above-described manner includes the second direction information. The second direction information corresponds to communication direction information, which indicates that the communication direction is the second direction. Specifically, a combination of NESN and SN having different values corresponds to the second direction information. When the communication frame, which includes the first direction information and is transmitted from the vehicle device 4, is received, the communication unit 24 generates the communication direction information in which the current pair frame information and the next pair frame information are different from one another as the second direction information.

In S575, the communication unit 24 determines whether the MD included in the header field of (i) the communication frame transmitted from the smart device 2 or (ii) the communication frame received from the vehicle device 4 is equal to 0 based on the information stored in the memory 231. In response to determining that the MD is equal to 1, the communication unit 24 returns to S510 and repeats the process from S510. In response to determining that the MD is equal to 0, the communication unit 24 ends the BLE communication process.

### 3. Effects

According to the above-described embodiment, the following effects can be achieved.

(3a) In the vehicle device 4 described above, in S170 or S175, the vehicle control unit 53 (that is, the BLE communication unit 55) generates the first direction information (that is, NESN and SN satisfying NESN=NS) and transmits the communication frame including the first direction information via the main antenna 51. In the smart device 2, in response to determining that the signal including the first direction information is received in S515, the portable control unit 23 (that is, the communication unit 24) generates the second direction information and transmits the communication frame including the second direction information in S535 or S545.

When the second direction information is included in the communication frame received by the sub-antenna 61, the monitoring control unit 63 (that is, the determination unit 59) determines that the transmission source of the communication frame is the smart device.

When the second direction information is included in the received communication frame, the vehicle device 4 determines that the transmission source of the received communication frame is the smart device 2. As a result, it is possible to more accurately specify a signal whose transmission source is the smart device 2 than in a case where a reception signal acquired at a preliminarily estimated time (for example, a time corresponding to end of interval period Ti) is always estimated as a signal whose transmission source is the smart device 2.

(3b) In the vehicle device 4 described above, when the determination unit 59 determines that the transmission source of the communication frame received by the sub-antenna 61 is the smart device 2, the position specifying unit 58 specifies the position of smart device 2 based on the reception strength of the received communication frame. Since the position is specified based on the reception strength of signal whose transmission source is specified as the smart device 2, it is possible to accurately specify the position of smart device 2.

(3c) In the vehicle device 4 described above, the communication direction information includes SN as the current pair frame information and NESN as the next pair frame information. The vehicle control unit 53 (that is, the BLE communication unit 55) generates communication direction information in which SN is equal to NESN as the first direction information. In the smart device 2 described above, the portable control unit 23 generates communication direction information in which NS is different from NESN as the second direction information.

That is, the communication direction and the transmission source are specified in response to whether the SN and NESN match or mismatch with one another. For example, when SN and NESN have the same value, it can be determined that SN and NESN match with one another. Accordingly, it is possible to specify the communication direction and the transmission source more easily than specifying the communication direction and the transmission source of the communication frame by identifying the portable ID or the vehicle ID included in the communication frame. As a result, the transmission source of communication frame can be specified with a simple configuration.

(3d) In the vehicle device 4 described above, the SN as the current pair frame information and the NESN as the next pair frame information are indicated by different numerical values. By using numerical values, the communication direction information can be easily represented. As a result, the transmission source of the communication frame can be specified with a simpler configuration.

(3e) In the vehicle device 4 described above, the SN as the current pair frame information and the NESN as the next pair frame information are set to either 0 or 1. That is, each of SN and NESN is represented by one bit numerical value. Accordingly, the communication direction information can be represented by a relatively small amount of information of 2 bits (that is, 2 bits for both SN and NESN).

(3f) In the vehicle device 4 described above, the communication direction information (that is, SN and NESN) is included in the unencrypted field of the communication frame. Accordingly, since it is not necessary to provide a function of decrypting the encrypted communication frame in order to specify the transmission source of the communication frame, it is possible to simply configure a device that receives the communication frame, such as the monitoring device 6 (that is, the monitoring receiver 62 or the monitoring control unit 63).

(3g) In the communication system 1 including the vehicle device 4 and the smart device 2, the wireless communication is executed under BLE standard. As a result, the vehicle device 4 and the smart device 2 that perform bidirectional BLE communication can accurately identify the transmission source of the communication frame.

### (Correspondence)

The communication system 1 in the above-described embodiment corresponds to a communication system, the vehicle device 4 corresponds to a first communication device and a vehicle device, and the smart device 2 corresponds to a second communication device. The main antenna 51 corresponds to a main antenna, the sub-antenna 61 corresponds to a sub-antenna, and the monitoring receiver 62 corresponds to a strength detector. The portable antenna 21 corresponds to a transmission reception antenna.

The vehicle control unit 53 and the BLE communication unit 55 correspond to a first communication execution unit, the monitoring control unit 63 and the determination unit 59 correspond to a transmission source determination unit, and the vehicle control unit 53 and the position specifying unit 58 correspond to a position specifying unit. The portable control unit 23 and the communication unit 24 correspond to a second communication execution unit. SN corresponds to the current pair frame information, NESN corresponds to the next pair frame information, and SN and NESN correspond to the communication direction information. SN and NESN satisfying NE=NESN correspond to first direction information, and NE and NESN satisfying NENESN correspond to second direction information. A communication frame and a communication frame indicating a data packet correspond to a communication frame for wireless communication.

### 4. Other Embodiments

Although the embodiments of the present disclosure have been described above, the present disclosure is not limited to the above-described embodiments and can be implemented with various modifications.

(4a) In the communication system 1 described above, frame division may not be executed. In this case, for example, the vehicle device 4 may omit the process executed in S120, S125, S130, S160, S165, S170, S175 illustrated in FIG. 10 and FIG. 11. The smart device 2 may omit the process executed in S555, S560, S565 shown in FIG. 15.

(4b) In the communication system 1 described above, NESN and SN are used as the communication direction information. The present disclosure is not limited thereto. For example, the communication direction information such as the current pair frame information and the next pair frame information may be assigned to a non-encrypted area (for example, a spare area in the header field) of the communication frame.

(4c) In the communication system 1 described above, the monitoring receiver 62 includes the determination unit 59. The present disclosure is not limited thereto. For example, the vehicle control unit 53 may include the determination unit 59.

(4d) In the communication system 1 described above, the vehicle device 4 may include one monitoring device 6. That is, the vehicle device 4 may include one sub-antenna 61.

(4e) In the communication system 1 described above, the wireless communication between the vehicle device 4 and the smart device 2 may be communication conforming to a communication standard other than BLE. The frequency band of the signal used for wireless communication may be a frequency band other than the 2.4 GHz band, which is used in BLE.

(4f) The vehicle control unit 53, the monitoring control unit 63, and the method thereof described in the present disclosure may be implemented by a dedicated computer provided by configuring a processor and a memory programmed to execute one or more functions embodied by a computer program. Alternatively, the vehicle control unit 53, the monitoring control unit 63, and the method thereof described in the present disclosure may be implemented by a dedicated computer provided by configuring a processor with one or more dedicated hardware logic circuits. Alternatively, the vehicle control unit 53, the monitoring control unit 63, and the method thereof described in the present disclosure may be implemented by one or more dedicated computers configured by a combination of (i) a processor and a memory programmed to execute one or more functions and (ii) a processor configured by one or more hardware logic circuits. The computer program may be stored in a computer-readable non-transitory tangible storage medium as instructions to be executed by a computer. The implementation manner of the functional units included in the vehicle control unit 53 and the monitoring control unit 63 does not necessarily include software, and all the functions may be implemented using one or more hardware circuits.

(4g) Multiple functions of one component in the above embodiment may be implemented by multiple components, and a function of one component may be implemented by multiple components. Multiple functions of multiple elements may be implemented by one element, or one function implemented by multiple elements may be implemented by one element. A part of the configuration of the above embodiments may be omitted as appropriate. At least a part of the configuration in one embodiment may be added to or substituted for the configuration of another embodiment.

(4h) In addition to the communication system 1, the vehicle device 4, the vehicle control unit 53, the monitoring control unit 63, the smart device 2, and the portable control unit 23 described above, the present disclosure can also be implemented in various forms such as a program that functions as the vehicle control unit 53, the monitoring control unit 63, and the portable control unit 23, a non-transitory tangible storage medium such as a semiconductor memory in which the program is recorded, a communication method, and a position detection method.

What is claimed is:

1. A vehicle device used in a communication system, the communication system including a first communication device and a second communication device, which perform a wireless communication with one another in bidirectional manner, the vehicle device being mounted on a vehicle and corresponding to the first communication device included in the communication system, the vehicle device comprising:
a main antenna performing signal transmitting and signal receiving;
at least one sub-antenna different from the main antenna, and the at least one sub-antenna performing signal transmitting and signal receiving, wherein a communication frame of the wireless communication, which is transmitted in a first direction from the first communication device to the second communication device, is paired with a communication frame of the wireless communication, which is transmitted in a second direction from the second communication device to the first communication device;
a first communication execution unit generating first direction information, which indicates a communication direction is the first direction, and transmitting the communication frame, which includes the generated first direction information, via the main antenna, wherein the first direction information corresponds to communication direction information, which is included in the paired communication frame and indicates the communication direction of communication frame; and
a determination unit determining whether a transmission source of the communication frame is the second communication device,
wherein
the second communication device is a portable device,
the second communication device includes:
a transmission reception antenna performing signal transmitting and signal receiving; and
a second communication execution unit generating second direction information, which indicates the communication direction is the second direction, and transmitting the communication frame, which includes the generated second direction information, in response to a signal including the first direction information being received via the transmission reception antenna, and
the determination unit determines that the transmission source of the communication frame is the second communication device when the communication frame received by the at least one sub-antenna includes the second direction information, which corresponds to the communication direction information and indicates that the communication direction is the second direction.

2. The vehicle device according to claim 1, further comprising:
a strength detector detecting a reception strength of a signal received by the at least one sub-antenna; and
a position specifying unit specifying a position of the second communication device based on the detected reception strength in response to the determination unit determining that the transmission source of the communication frame received by the at least one sub-antenna is the second communication device.

3. The vehicle device according to claim 1, wherein
the communication frames paired with one another is defined as a pair frame,
the communication direction information includes current pair frame information and next pair frame information,
the current pair frame information indicates the pair frame, which includes the communication frame to be transmitted,
the next pair frame information indicates the pair frame, which includes the communication frame to be received next time,
in the first communication device, the first communication execution unit generates, as the first direction information, the communication direction information in which the current pair frame information and the next pair frame information are equal to one another, and
in the second communication device, the second communication execution unit generates, as the second direction information, the communication direction information in which the current pair frame information and the next pair frame information are different from one another.

4. The vehicle device according to claim 3, wherein
the current pair frame information and the next pair frame information are indicated by numerical values.

5. The vehicle device according to claim 3, wherein
the current pair frame information and the next pair frame information each is represented by 0 or 1.

6. The vehicle device according to claim 1, wherein
the communication direction information is included in an unencrypted field of the communication frame.

7. The vehicle device according to claim 1, wherein
the wireless communication between the first communication device and the second communication device is a wireless communication under Bluetooth Low Energy (Bluetooth is a registered trademark) standard.

8. A communication system comprising:
a first communication device; and
a second communication device, the first communication device and the second communication device performing a wireless communication with one another in bidirectional manner,
wherein the first communication device includes:
a main antenna performing signal transmitting and signal receiving;
at least one sub-antenna different from the main antenna, and the at least one sub-antenna performing signal transmitting and signal receiving, wherein a communication frame of the wireless communication, which is transmitted in a first direction from the first communication device to the second communication device, is paired with a communication frame of the wireless communication, which is transmitted in a second direction from the second communication device to the first communication device;
a first communication execution unit generating first direction information, which indicates a communication direction is the first direction, and transmitting the communication frame, which includes the generated first direction information, via the main antenna, wherein the first direction information corresponds to communication direction information, which is included in the paired communication frame and indicates the communication direction of communication frame; and
a determination unit determining whether a transmission source of the communication frame is the second communication device,
the second communication device is a portable device and includes:
a transmission reception antenna performing signal transmitting and signal receiving; and
a second communication execution unit generating second direction information, which indicates the communication direction is the second direction, and transmitting the communication frame, which includes the generated second direction information, in response to a signal including the first direction information being received via the transmission reception antenna, and
in the first communication device, the determination unit determines that the transmission source of the communication frame is the second communication device when the communication frame received by the at least one sub-antenna includes the second direction information, which corresponds to the communication direction information and indicates that the communication direction is the second direction.

9. A vehicle device mounted on a vehicle and performing a wireless communication in a bidirectional manner with a portable device, the vehicle device comprising:
a main antenna performing signal transmitting and signal receiving;
at least one sub-antenna different from the main antenna, and the at least one sub-antenna performing signal transmitting and signal receiving, wherein a communication frame of the wireless communication, which is transmitted in a first direction from the vehicle device to the portable device, is paired with a communication frame of the wireless communication, which is transmitted in a second direction from the portable device to the vehicle device;
a computer-readable non-transitory storage medium; and
a processor, by executing program code stored in the computer-readable non-transitory storage medium, configured to:
generate first direction information, which indicates communication direction is the first direction;
transmit the communication frame, which includes the generated first direction information, via the main antenna, wherein the first direction information corresponds to communication direction information, which is included in the paired communication frame and indicates the communication direction of communication frame; and
determine whether a transmission source of the communication frame is the portable device,
wherein
the portable device includes:
a transmission reception antenna performing signal transmitting and signal receiving;
a computer-readable non-transitory storage medium; and
a processor, by executing program code stored in the computer-readable non-transitory storage medium, configured to:
generate second direction information, which indicates the communication direction is the second direction; and
transmit the communication frame, which includes the generated second direction information, in response to a signal including the first direction information being received via the transmission reception antenna, and
the processor of the vehicle device is configured to determine that the transmission source of the communication frame is the portable device when the communication frame received by the at least one sub-antenna includes the second direction information, which corresponds to the communication direction information and indicates that the communication direction is the second direction.
